(19) United States
(12) Patent Application Publication
(10) Pub. No.: US 2023/0058151 A1
(43) Pub. Date: Feb. 23, 2023

(54) Cladded Wall System

(71) Applicant: Ofer Porat, Kiryat Tiv'on (IL)

(72) Inventor: Ofer Porat, Kiryat Tiv'on (IL)

(21) Appl. No.: 17/796,918

(22) PCT Filed: Feb. 7, 2021
(86) PCT No.: PCT/IL2021/050144

§ 371 Date: Aug. 2, 2022

(30) Foreign Application Priority Data
Feb. 6, 2020 (IL) 272515

(51) Int. Cl. E04C 2/292; E04G 17/065; E04B 1/80; E04B 2/86; E06B 1/70; E04B 1/41

(52) U.S. Cl. CPC E04C 2/292; E04G 17/065; E04B 1/80; E04B 2/8635; E06B 1/702; E04B 1/40; E04B 2001/405

(57) ABSTRACT

A cladded wall system for constructing cladded cast-in-place concrete walls that are each integrated with lost forms comprising a self-supporting structure made of a plurality of prefabricated cladded panels (PCPs) constituting an exterior lost form, at least one architectural element constituting an interior lost form, and a plurality of concrete integratable connecting units by which each of said PCPs is connected to said interior lost form.

### FIELD OF THE INVENTION

The present invention relates to the field of wall construction. More particularly, the invention relates to a cladded wall system.

### BACKGROUND OF THE INVENTION

With respect to the current construction market in Israel and in other countries, there is a demand as well as a preference for stone cladded buildings by virtue of the esthetic appeal and durability of stone. Prior art stone cladding is attached by anchors or by adhesive to exterior walls constructed from poured concrete or insulated prefabricated construction blocks with labor intensive, costly and time consuming methods. Additionally, moisture is often trapped behind the cladding if poorly sealed, leading to its detachment from the wall.

The long duration of the prior art construction process is affected by the need to construct a conventional frame, and then to apply layers of extemal cement coatings to the frame by specialized skilled subcontractors that work on scaffoldings attached to the external walls. The need to cure each of the applied layers leads to unwanted delays at the building site. Recent studies have shown that a determining factor in establishing a timeline of a typical construction project is the delay involved in waiting for skilled workers to apply the exterior finish at the site. The finishing process is serial, usually being dependent upon different subcontractors that do not work simultaneously and therefore may be unavailable whenever a coordinating problem is found and are requested to retum to the construction site. Accordingly the prior art construction process leads to very limited responsibility and poor quality despite the high costs and time spent on the project.

It is an object of the present invention to provide a cladded wall system that reduces the installation time relative to prior art methods.

It is an additional object of the present invention to provide a cladded wall system of high quality whereby its esthetic appearance is considerably more long lasting than that of prior art methods.

It is an additional object of the present invention to provide a cladded wall system that enables architectural flexibility.

It is yet an additional object of the present invention to provide a cladded wall system that does not require dangerous external scaffolding to install the cladding.

It is yet an additional object of the present invention to provide a cladded wall system that facilitates a constant flow of construction without unwanted delays.

Other objects and advantages of the invention will become apparent as the description proceeds.

### SUMMARY OF THE INVENTION

A cladded wall system for constructing cladded cast-in-place concrete walls that are each integrated with lost forms comprises a self-supporting structure made of a plurality of prefabricated cladded panels (PCPs) constituting an exterior lost form, at least one architectural element constituting an interior lost form, and a plurality of concrete integratable connecting units by which each of said PCPs is connected to said interior lost form.

Each of the PCPs comprises at least:
a) a support board and a cladding plate that is factory adhered to said support board;
b) exterior and interior support boards, a socket element received in aligned openings formed in said exterior and interior support boards, and an insert anchor in contact with said exterior board and introduced in said socket element, wherein a fastener associated with one of the connecting units is introduced in said socket element and is engaged with said insert anchor to tighten the PCP, and the cladding plate is factory adhered to said exterior support board; or
c) an insulating plate interposed between the exterior and interior support boards and which is formed with an opening within which the socket element is received.

In one aspect, a first region of the insulating plate is configured with a tongue and a second region of the insulating plate is configured with a groove, to facilitate interlocking of adjacent PCPs by a tongue and groove arrangement. A sealant may fill the tongue and groove interlocking connection to retard or to completely prevent water infiltration.

The PCP is thus a factory made product that provides:
alignment and fixation;
sealing and insulation;
an exterior finish; and
an exterior concrete bearing wall lost form.

The use of PCPs dramatically reduces work stages at the construction site in that the dry assembly operations do not necessitate delays during transitional work stages from floor to floor.

In one aspect, each of the connecting units comprises an elongated metal mount in abutment with the interior support board and through an opening of which the fastener is introduced into the socket element, and a bracket connected to said metal mount which is connected to one of the architectural elements constituting an interior lost form. First and second metal mounts are fixated together to produce a reinforced member that both presses on one PCP and vertically extends along two PCPs to ensure that said two PCPs will be vertically aligned.

A PCP structure constituting a portion of an exterior lost form may comprise four metal mounts connected to the interior support board, including two short mounts and two long mounts; the mounts are arranged in such a way that they support every PCP by the one below it. The mounts constitute a metal chassis that are connected the PCP via hidden sockets that are arranged in a specific array.

Detailed fixation and sealed connections between the exterior elements that comprise the exterior form are made possible. It is to be said, that the failure of most prefabricated concrete prior art methods is the result of inadequate connections between the precast elements. In contrast, the cladded wall system incorporates unique integrated fixation means that aligns the elements during the connecting process.

The wall system comprising such PCP structures facilitates building in one phase a massive lost forming mold that incorporates most elements of a conventional wall, including structural elements, a complete external finish, and architectural details relating to wall openings.

The more complicated of material and form connections such as corners, lintels, window jambs and sills are advantageously standardized. The PCPs offer industrial precision that is 50 times more accurate than conventional construction standards. In anticipation of high structure precision, wall opening elements can be assembled in advance prior to being installed in the structure since such wall openings are known that they will meet construction standards.

In one aspect, the wall system further comprises a handle bar unit that is detachably connectable to two of the metal mounts, to facilitate safe transfer of the PCP at the construction site.

In one aspect, the bracket is configured with one or more grooves to receive and support a horizontal rebar element.

In one aspect, the bracket is configured with a perforated plate formed with a plurality of apertures and adapted to be in abutting relation with the concrete-based panel, through one of the apertures a drilling screw drilled through the concrete-based panel is able to be received in one of the apertures in order to fixate the interior and exterior lost forms together. All perforated plates corresponding to each of the connecting units are preferably coplanar.

In one aspect, one of the architectural elements constituting an interior lost form is a concrete-based panel, such as an autoclaved aerated concrete panel.

In one aspect, the architectural element constituting an interior lost form is an existing wall of a building that will undergo a retrofitting operation.

In one aspect, the wall system further comprises a leveling unit.

### BRIEF DESCRIPTION OF THE DRAWINGS

In the drawings:

FIG. 1 is an exploded exterior view of an embodiment of a prefabricated construction unit that includes a prefabricated cladded panel;

FIG. 2 is an exploded interior view of the prefabricated construction unit that includes of FIG. 1;

FIG. 3 is an exterior view of an embodiment of a prefabricated cladded panel structure;

FIG. 4 is an interior view of prefabricated cladded panel structure of FIG. 3, showing a plurality of reinforced post members;

FIG. 5 is a horizontal cross section view of an embodiment of a prefabricated cladded panel;

FIG. 6 is an exterior view of an embodiment of a cladded wall system before concrete has been poured into its interior;

FIG. 7 is a vertical cross sectional view of the cladded wall system of FIG. 6, after concrete has been poured in its interior;

FIG. 8 is an interior view of another prefabricated cladded panel structure, showing a single reinforced post member;

FIG. 9 is an interior view of another prefabricated cladded panel structure;

FIG. 10 is a horizontal cross section view of another embodiment of a prefabricated cladded panel;

FIG. 11 is an exterior view of another embodiment of a cladded wall system before concrete has been poured into its interior;

FIG. 12 is another exterior view of the cladded wall system of FIG. 11 before concrete has been poured into its interior;

FIG. 13 is an exterior view of a cladded window opening unit before being connected to a prefabricated cladded panel structure;

FIG. 14 is an exploded view of the cladded wall system of FIG. 11;

FIGS. 15A-15B show two options of vertical cross-sectional views of a lowermost tier of the cladded wall system of FIG. 6 before concrete has been poured into its interior, showing a leveling unit;

FIG. 16 is a perspective view from the interior of another embodiment of a cladded wall system before concrete has been poured into its interior;

FIG. 17 is an interior view of a prefabricated cladded panel structure to which has been coupled a detachable handle bar unit;

FIG. 18 is an exterior view of another embodiment of a cladded wall system before concrete has been poured into its interior;

FIG. 19 is an exterior view of another embodiment of a cladded wall system before concrete has been poured into its interior; and

FIG. 20 is a perspective view from above of a bracket used in conjunction with the cladded wall system of FIG. 19.

### DETAILED DESCRIPTION OF THE INVENTION

The cladded wall system facilitates the construction of a building with cast-in-place concrete walls that are each integrated with lost forms, including a self-supporting structure made of a plurality of prefabricated cladded panels constituting the exterior form. The cladded walls using the prefabricated cladded panels are able to be constructed considerably more accurately, quickly and with longer term visual appeal than those built according to prior art methods.

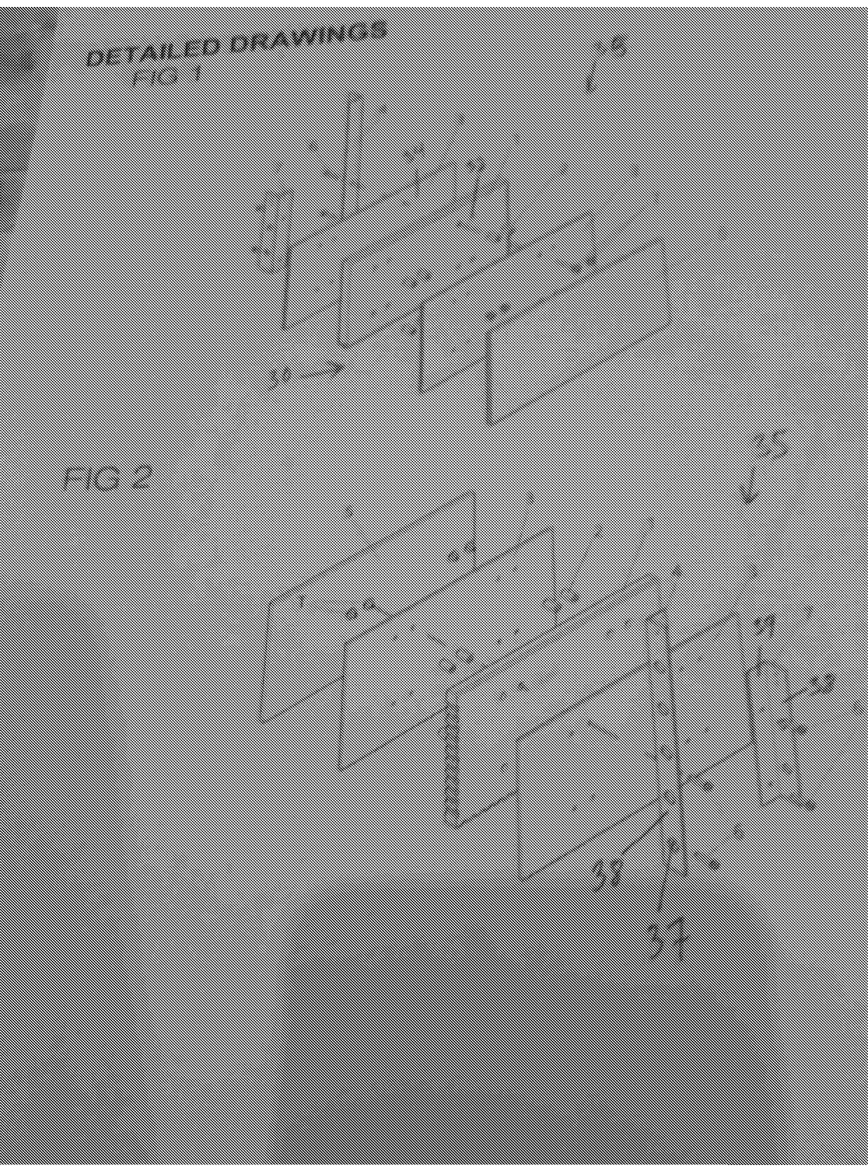

FIG. 1 is an exploded exterior view of a prefabricated cladded panel (PCP) (30), i.e. a view generally taken from outside of a building in which the PCP is installed, according to an embodiment of the invention.

The PCP, which generally has a rectangular configuration, comprises a highly insulating and lightweight soft-material plate (1), preferably having a thickness of at least 1 cm, which may be a foam plate and made of a material such as phenol formaldehyde plastic, high-density polyethylene, polyvinylchloride, polystyrene, rock wool, or other insulating element. The large-area surface of plate (1) is perforated with an array of large through-openings (32) within each of which an insert (2), e.g. metallic and of an annular cross section, is fixatable. Plate (1) is supported at its interior and exterior sides by a corresponding support board (3), which may be a cement board, a fiber cement board, a high pressure laminate (HPL) board, or made of any other artificial or natural material. The support boards (3) have a similar array of openings (34) that are alignable with those of plate (1), such that, when an insert (2) which is longer than the thickness of board (3) is received in a corresponding opening (34), a through-opening is provided by each insert (2) that has a smaller diameter then the corresponding opening (32) of plate (1).

An angled metallic post (4) is positioned at the interior side of PCP (30), and has two through-openings that are alignable with the two through-openings (34) of the inner board (3). A mechanical metallic flat-head insert anchor known as a Tee Nut (T) is fixed through the exterior side of the exterior board (3). A bolt (6) is introduced through post (4), the two boards (3), insert (2), plate (1) and insert anchor (T) when aligned together. Each of the bolts (6) is threadedly coupled with a central fastener portion substantially perpendicular to the head of the corresponding insert anchor (T), so as to tighten the two boards (3) together while the head contacts the exterior board (3). Another angled metallic post (7), which may be shorter than post (4), is similarly connected. A thin cladding plate (5), which is generally a thin stone slab, but which may also be made of artificial, mineral or other natural materials, is adhesively affixed to the exterior board (3). Cladding plate (5) is adhesively affixed in a factory setting by means of controlled and adequate curing conditions in order to ensure accurate and effective adhesion.

Exemplary dimensions of PCP (30) are a length of 120 cm and a width of 30 cm, providing a panel weight that is suitable to be hand lifted.

PCP (30) and angled posts (4) and (7), e.g. metallic, together constitute a prefabricated construction unit (PCU) (35).

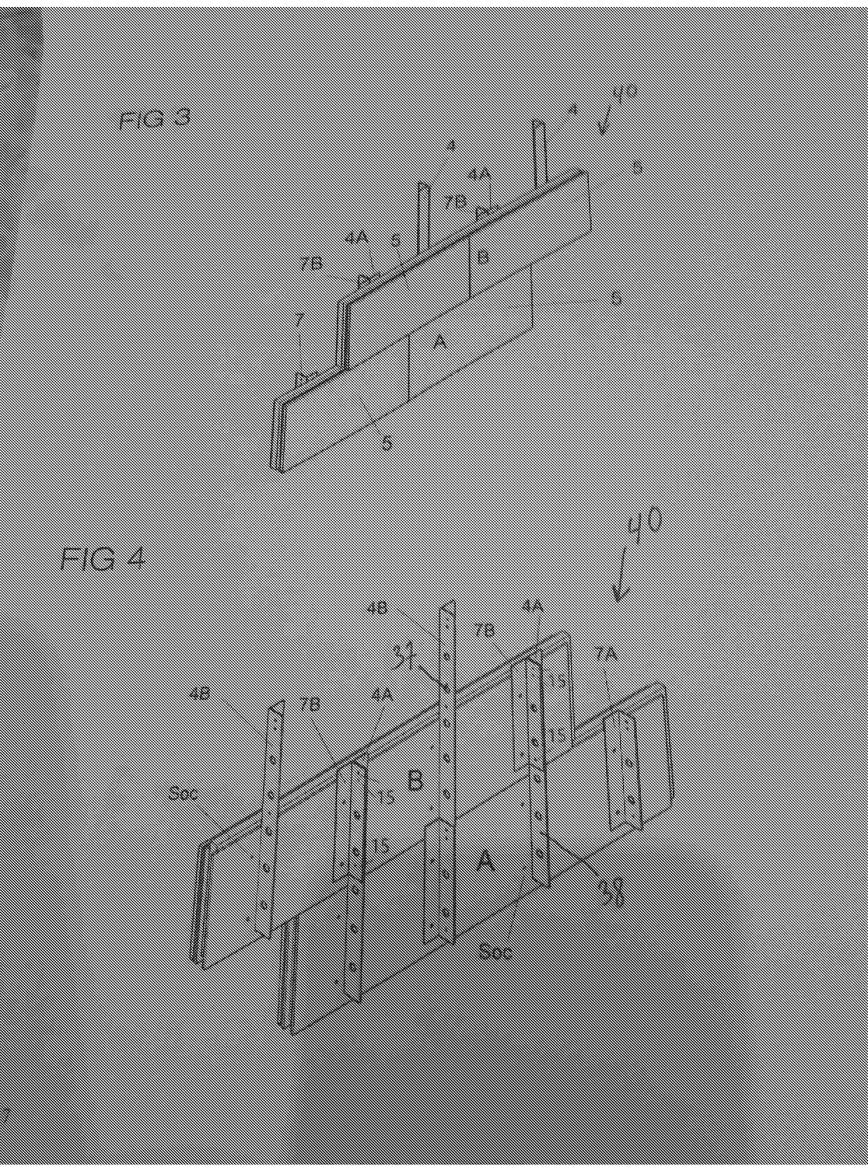

FIG. 2 is an exploded interior view of the same PCU (35). Long, angled metal post (4), which is fixed to PCP (30) by bolts (6) passing through the corresponding openings formed in the boards (3) and in plate (1) and through insert anchor (T), is configured with a vertical array of large openings (37), e.g. five, formed in one of its sides, facilitating connection with a detachable handle bar unit, as will be explained. Short, angled metal post (7), shown to be configured with e.g. two large openings (37), may be fixed to the inner board (3) in a similar manner. The two angled posts (4) and (7), each of which generally configured with two substantially perpendicular sides (38) and (39), may be positioned such that each side (38) thereof formed with the openings (37) face each other as illustrated.

FIG. 3 is an exterior view of a self-supporting PCP structure 40, shown for example with two PCPs. PCP panel (A) is positioned on a bottom tier of structure 40, and PCP panel (B) is positioned at a tier above the bottom tier, being in abutting relation with panel (A) such that the cladding plates (5) of panels (A) and (B) are coplanar and panel (B) is laterally shifted relative to panel (A). Structure 40 is self-supporting in that each PCP panel is supported and aligned by one or more PCP panels of the tier immediately therebelow. The self-supporting feature is made possible by fixating posts (4) and (7) together with use of self-taping metal screws that pass through the two posts until they are threadedly locked to produce a reinforced post member (4A-7B) that both presses on one PCP panel and vertically extends along two PCP panels to ensure the vertical alignment.

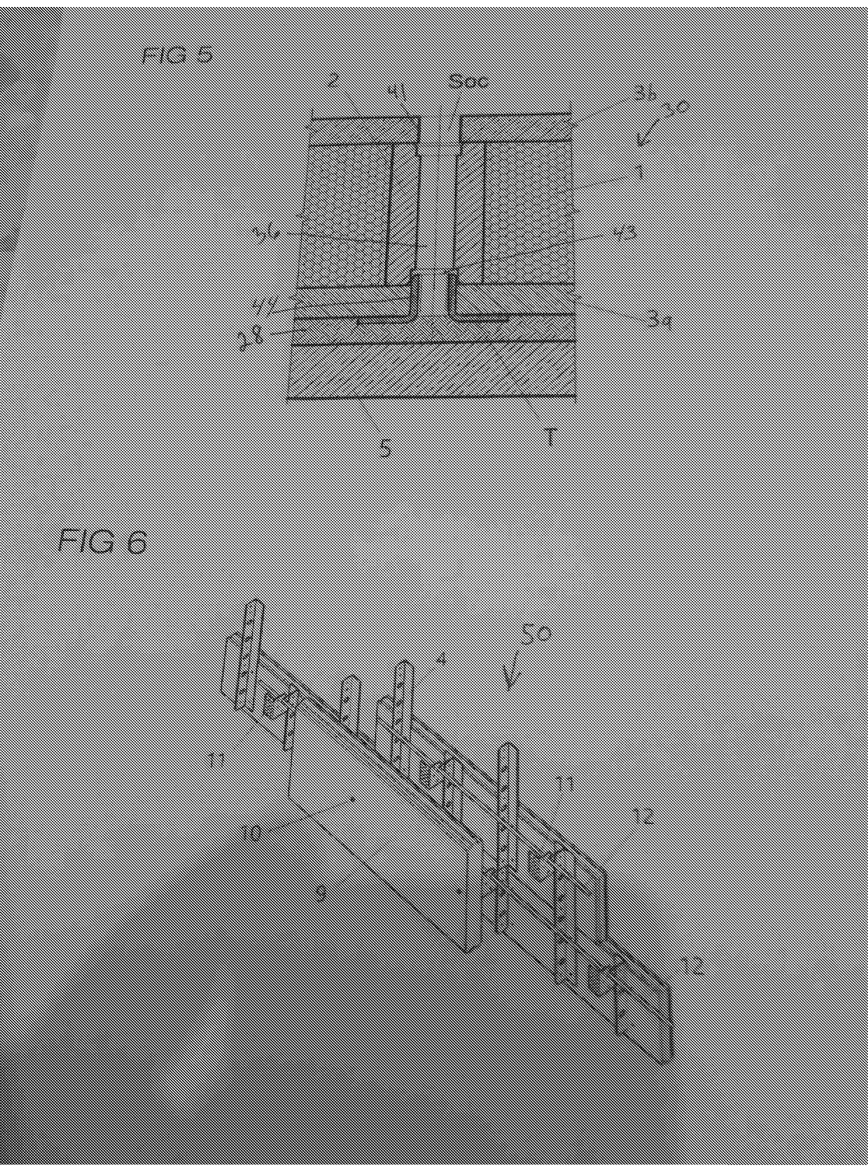

As shown in FIG. 4, a reinforced post member (RPM) of PCP structure (40) may comprise a short post (7B) fixed to an upper-tier panel and a long post (4A) fixed to both upper-tier and lower-tier panels to produced reinforced post member (4A-7B), or a short post (7A) fixed to a lower-tier panel and a long post (4B) fixed to both upper-tier and lower-tier panels to produced reinforced post member (4B-7A). Post (4B) may be longer than post (4A) and configured with seven openings (37). In each reinforced post member, the two sides (38) of each post are in abutting relation with each other such that the openings (37) of each are aligned with each other and a plurality of screws (15) pass through the two abutting sides (38).

FIG. 5 is a horizontal cross section of PCP (30), showing the configuration of its anchor socket (Soc), which contributes to the dimensional accuracy of PCP (30) and of the entire wall system.

PCP (30) comprises insulating plate (1) that is interposed between two support boards (3a) and (3b), insert anchor (T) received in a small through-opening formed in the exterior board (3a), adhesive layer (28) applied to the head of insert anchor (T) and to the entire exterior board (3), and cladding plate (5) affixed to adhesive layer (28). Adhesive layer (28) may be a C1TE-class cladding adhesive having a thickness of up to 1 cm that complies with building codes.

Insert (2), which may be made of a hard polymer such as POM or metal, is insertable within the large through-opening formed in insulating plate (1) and within the small through-opening formed in each of exterior board (3a) and interior board (3b), providing a socket cavity (36) through which bolt (6) shown in FIG. 1 is insertable of a smaller diameter than the small through-openings (34). The diameter of each small through-opening (34) may range from 0.6-20 mm. To accommodate this size limitation, insert (2) has a thick-wall central body formed with socket cavity (36) that is adapted to be received within the large through-opening (32) shown in FIG. 1, and a thin-walled protruding element (41) protruding from the central body that is adapted to be received in the small through-opening formed in interior board (3b). The central body may be formed with a first annular shoulder (43) slightly spaced from the edge of exterior board (3a), which is able to be contacted by central fastener portion (44) of insert anchor (T), and a second annular shoulder aligned with the edge of interior board (3b).

The structurally strong insert (2) absorbs the applied compressive forces when fastener portion (44) of insert anchor (T) is threadely coupled with a bolt (6) that causes the two boards (3a) and (3b) to be tightened together, to prevent damage to the soft-material plate (1).

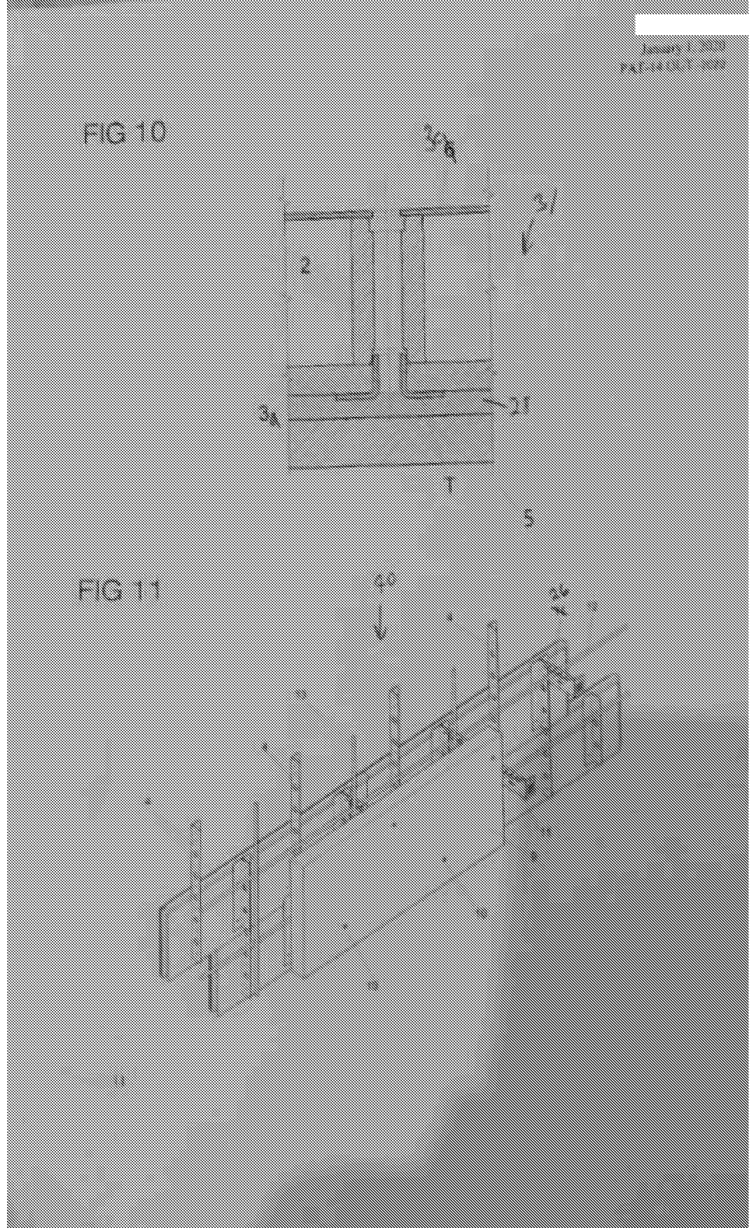

A PCP (30) may be configured with a plurality of interspersed sockets (Sac), as shown for example in FIGS. 4 and 8, for increased flexibility during assembly of a PCP structure, For example, if a reinforced post member has to be repositioned, insert (2) is simply removed from a first opening after interior board (3b) is separated from insulating plate (1) and inserted in a second opening.

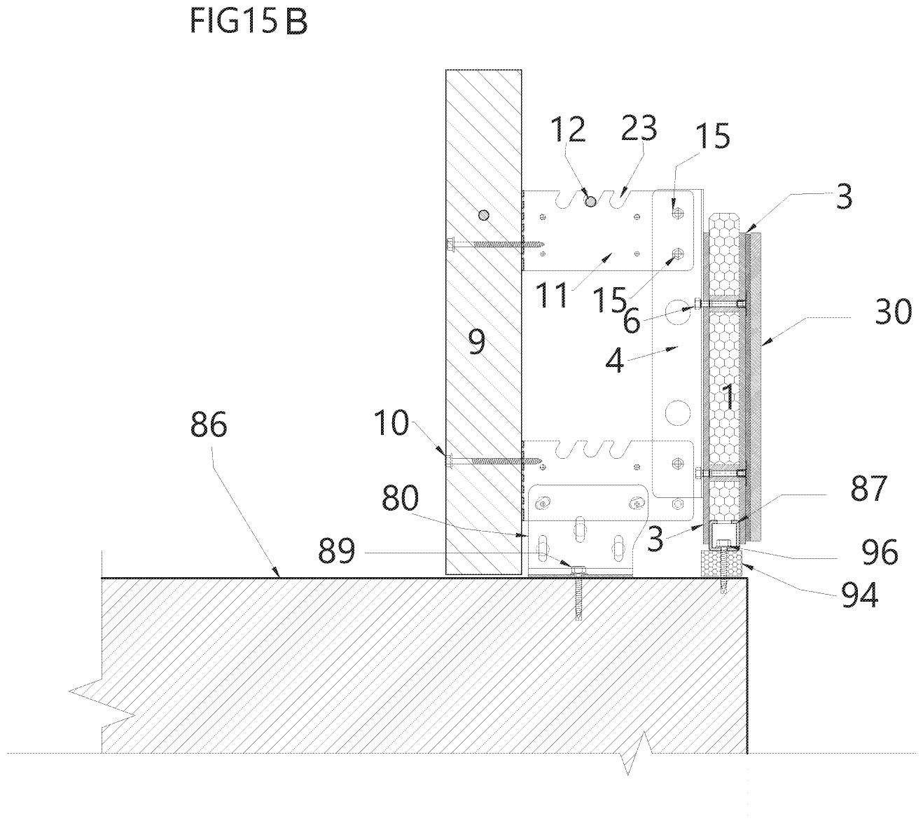

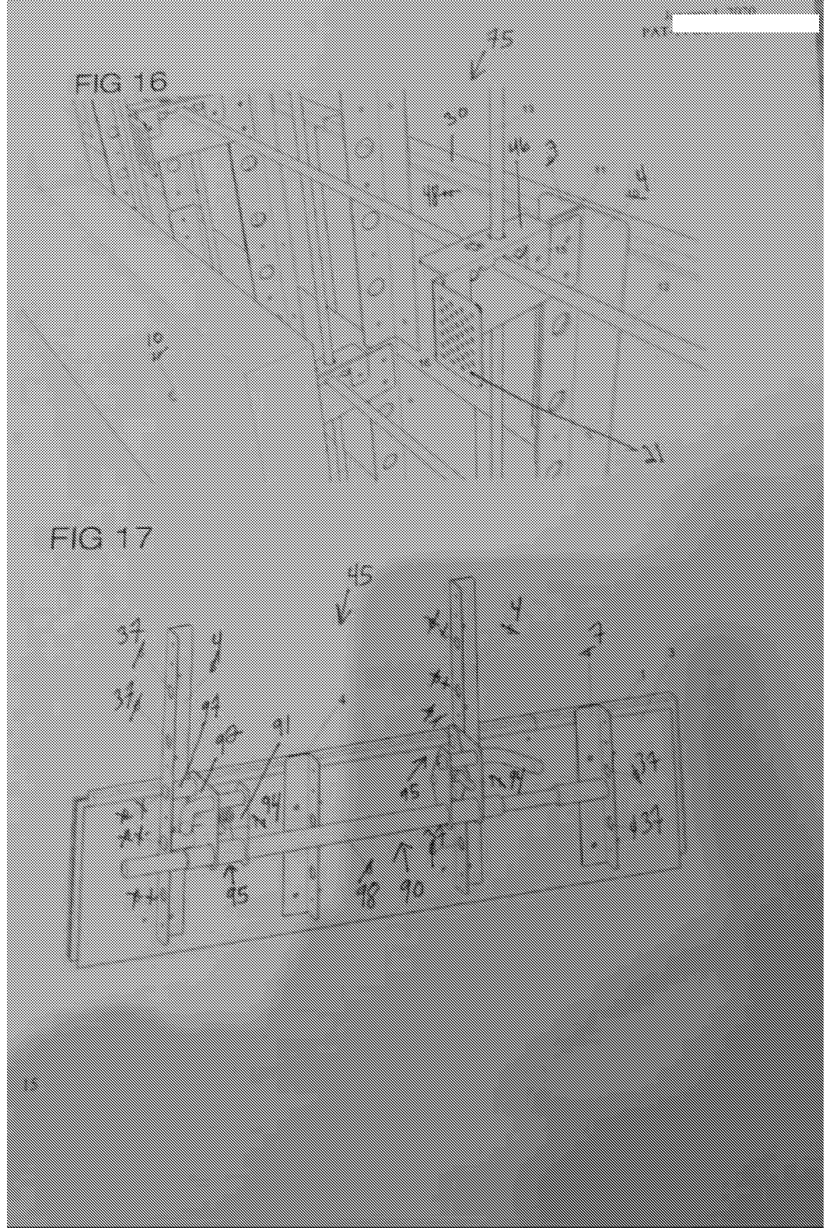

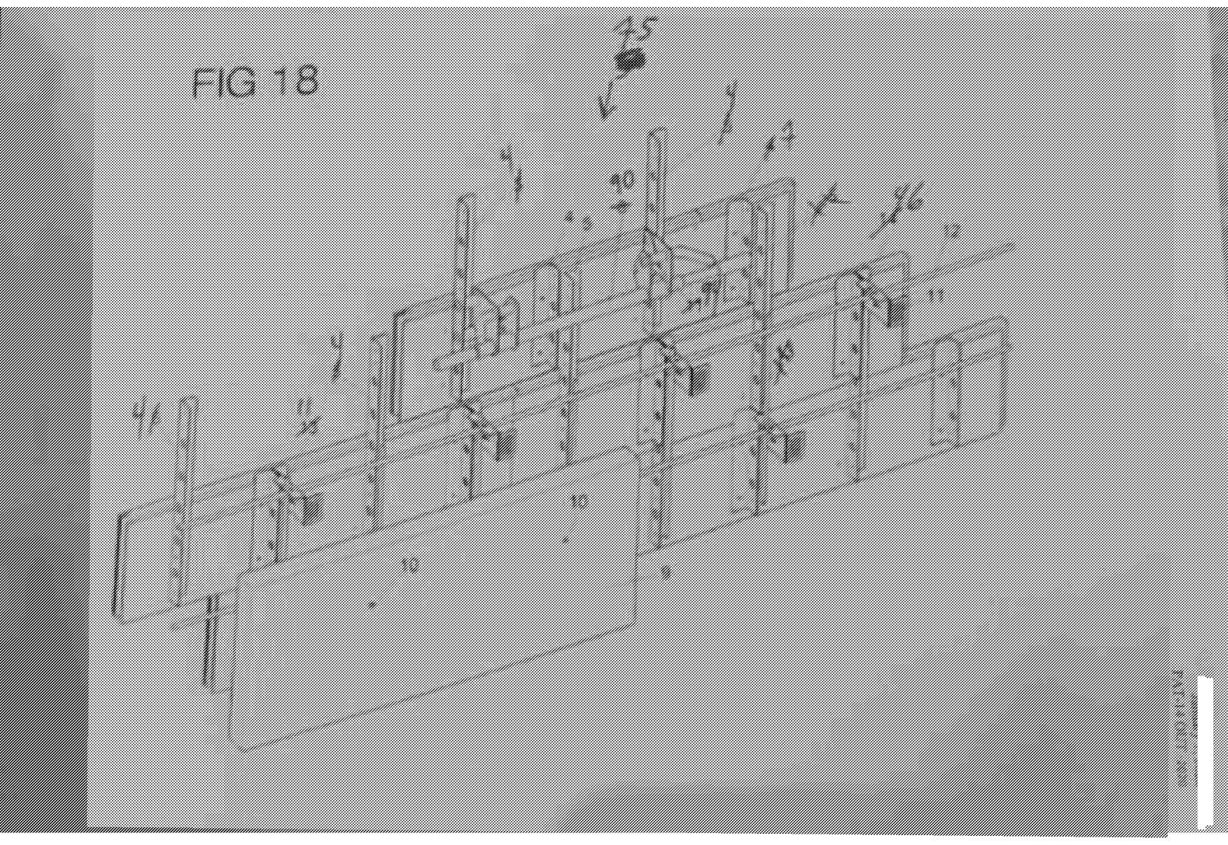

FIG. 6 is an isometric view of a lost form wall system (50) before concrete has been poured within its interior. Lost form wall system (50) comprises a plurality of PCPs (30), e.g. three PCP panels, constituting an exterior wall of the wall system, and one or more concrete-based panels (9) constituting an interior wall of the wall system, which are spaced from, and at least partially connected to, the plurality of PCPs (30). Each of the concrete-based panels (9) may be, for example, a standard lightweight concrete slab or an autodaved aerated concrete (AAC) panel. A self-taping screw (10) drills through the concrete-based panel (9) preferably by a cordless impact wrench, and engages the corresponding metal L-shaped bracket (11) on the opposite side of slab (9) that is connected to an angled post (4) or (7) of the plurality of PCPs (30). Each of the plurality of brackets (11) provided with wall system (50) are vertically aligned, allowing an angled groove (23) formed in each bracket (FIG. 15A) to hold a horizontal rebar element (12) extending within the interior of wall system (50). The configuration of bracket (11) is shown more clearly in FIG. 16.

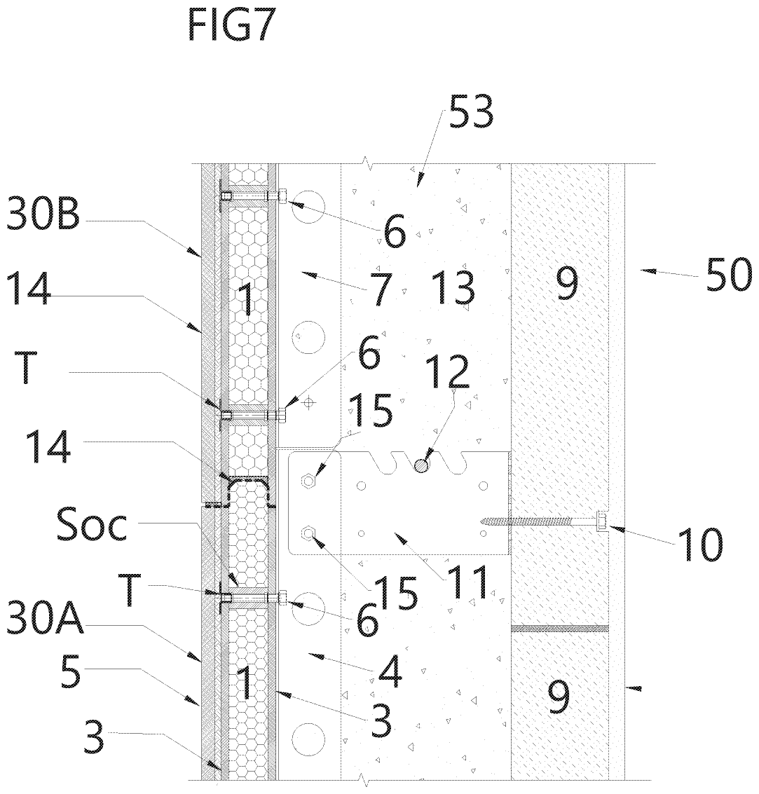

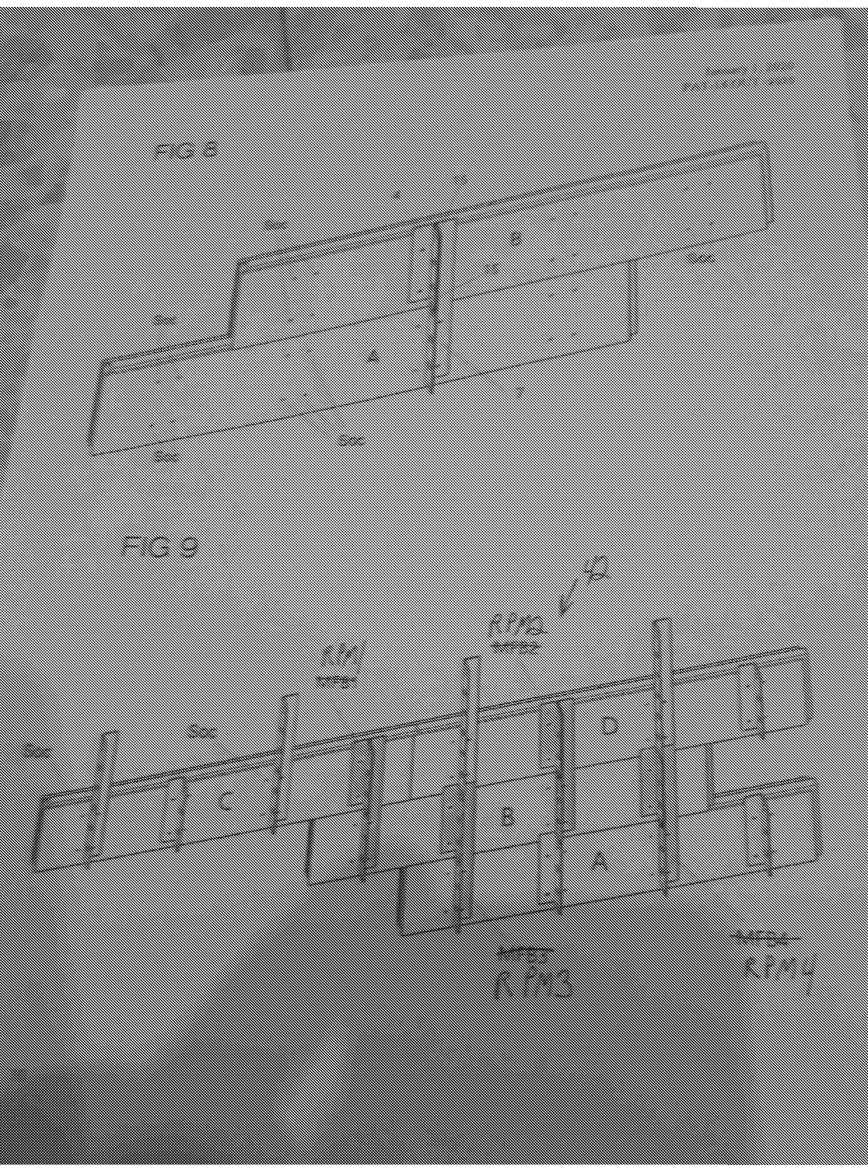

FIG. 7 is a vertical cross-sectional view of wall system (50) after concrete has been poured within its interior, showing concrete layer (53) and a rebar element (12) received in an angled groove of bracket (11) that has been integrated with concrete layer (53).

To facilitate the self-supporting capability of the PCP structure, an upper-tier PCP (30A) and a lower-tier PCP (30B) are interlocked by a tongue and groove interlocking connection (14) that is provided in vertically adjacent insulating plates (1). Likewise laterally adjacent PCPs are able to be interlocked by a tongue and groove interlocking connection (14). The tongue and groove interlocking connection (14) also serves to distribute the stress resulting from the attachment of bracket (11) to post (4) by screws (15) and the attachment of concrete-based panel (9) to bracket (11) by drilling screw (10). During assembly at the construction site, the tongue and groove interlocking connection (14) may be filled with a sealant such as expanding foam to retard or to completely prevent water infiltration.

A single RPM connected to PCPs (A) and (B) is shown in FIG. 8. The RPM is fabricated from a long post (7) and a short post (4), while abutting sides thereof are affixed together by a plurality of sheet metal screws (15).

FIG. 9 illustrates another PCP structure (42) which comprises panels (A), (B), (C) and (D) arranged in three tiers and four reinforced post members (RPM1-4). RPM1 is connected to panels (B) and (C), and the three laterally spaced (RPM2-4) are all connected to the panels (A), (B) and (D) which are arranged in three tiers.

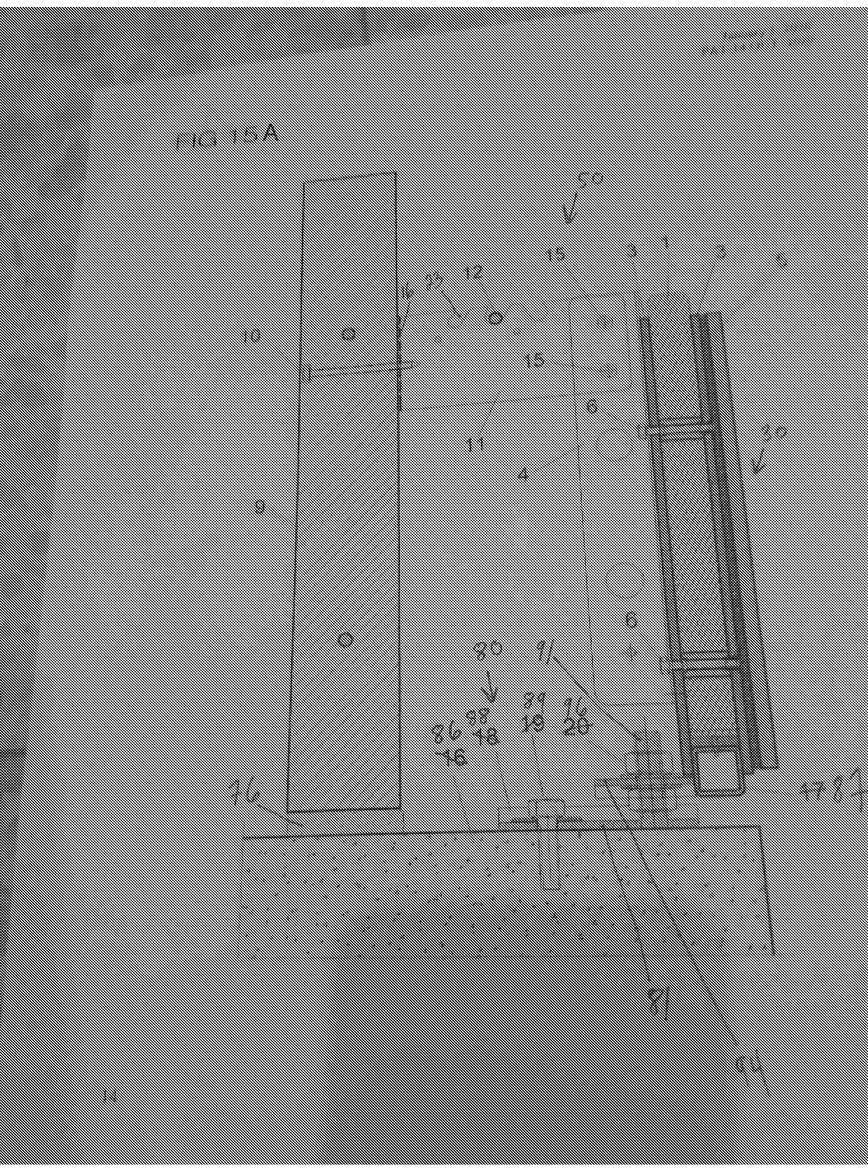

FIG. 13 illustrates a cladded window opening unit (105) that is able to be connected to a PCP structure whereby cladding elements (5) thereof are visible. Cladded window opening unit (105) comprises metal window frame sections (104), generally made from aluminum, and custom-cut PCPs (108) that are connected to each frame section (104) through selected sockets (Soc) to constitute for example a window jamb, window lintel or a window sill. A window sill (109) made from a single custom-cut PCP is shown.

Other architectural elements are likewise able to be connected to a PCP structure.

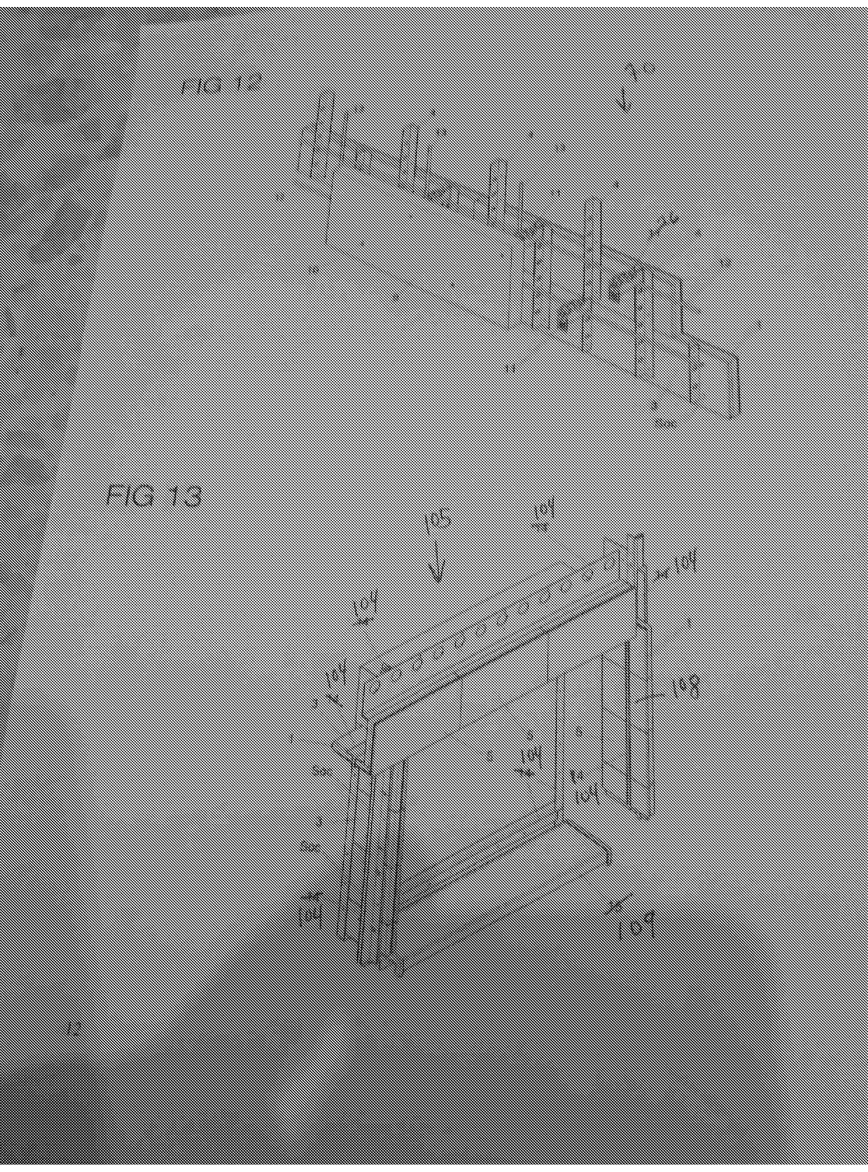

Alternatively, a PCP (31) shown in FIG. 10 may be employed. PCP (31) is identical to PCP (30) of FIG. 5, with the exception that the insulating plate is dispensed with and the outer board is replaced with a thin metal sheet (3c), to reduce the thickness of the panel. PCP (31) may be employed in any structure or wall system described herein.

FIG. 17 illustrates a PCU (45) to which is coupled a detachable handle bar unit (90). Since a PCU is relatively heavy, for example weighing on the order of 20 kg, and unstable due to the presence of the angled posts, a construction worker attempting to lift a PCU that is lying on the cladding element is liable to have his fingers jammed below the cladding element or accidentally drop the PCU due to the concentrated load. By providing the handle bar unit (90), PCU (45) can be conveniently held by construction workers when carried to its designated place at the wall system on the construction site.

Detachable handle bar unit (90) comprises tubular bar (98), and longitudinally spaced locking assemblies (95) fitted over bar (98). Each locking assembly (95) has first (91) and second (92) differently sized plates, each configured with an aperture to receive bar (98), and a spring loaded lever (94) movably connected therebetween. The second, larger sized plate (92) has two vertically spaced pegs (97) that longitudinally protrude therefrom. When lever (94) is actuated, the spring expands and separates plates (91) and (92) one from the other, causing the pegs (97) to be received and secured within corresponding large openings (37) of one of the two long posts (4). This procedure is reversed to detach handle bar unit (90) from PCU (45).

FIG. 15A is a vertical cross-sectional view of a lowermost tier of wall system (50) before concrete has been poured within its interior, to illustrate a leveling unit (80) interfacing with concrete floor foundation (86) that ensures parallelism between PCP (30) and concrete-based panel (9). A plurality of separated leveling units (80) is provided throughout the length of the wall, for example at a distance of 1 m between adjacent leveling units.

Leveling unit (80) comprises a metal plate (81) formed with an aperture that is positioned on top of foundation (86) and is secured to the foundation by a drilled bolt (89) provided with a washer that passes through the aperture. A threaded rod (91) integrated with plate (81) extends upwardly therefrom from a plate region that is adapted to be adjacent to PCP (30). Footer (88), such as made of concrete, is applied to plate (81) to strengthen the rod-plate interface despite the load to be imposed by the PCPs (30).

An alignment plate (94) welded to a single leveling bar (87) extending throughout the length of the wall to be constructed is introduced over threaded rod (91) by a dedicated aperture and is secured between two axially spaced nuts (96) that are threadedly engaged with threaded rod (91). Leveling bar (87), which is adapted to support a PCP structure, may have a square cross section with a hollow interior. The height of leveling bar (87) can therefore be adjusted by correspondingly adjusting one of the nuts (96).

Since foundation (86) is not always level at certain regions thereof, leveling bar (87) which is secured by the foundation will therefore not always have a completely uniform height. To ensure that leveling bar (87) will have a completely uniform height, one or more of the leveling units (80) is adjusted so that the lower edge of a leveling bar region corresponding to the leveling unit will be either raised or lowered until the entire leveling bar (87) will have a completely uniform height.

The illustrated lowermost tier of the PCPs (30), including cladding plate (5), will therefore be completely vertically oriented when positioned in abutting relation on top of leveling bar (87). Leveling bar (87) is configured to protrude downwardly from support boards (3) when PCP (30) is positioned on top of the leveling bar, allowing alignment plate (94) to extend into the wall system interior without interference.

While PCP (30) is positioned on top of leveling bar (87) and is assured of being leveled, L-shaped bracket (11) is connected to post (4), and therefore plate (16) thereof is also assured of being vertically oriented. Mortar (76) interfacing between the lower-tier concrete-based panel (9) and foundation (86) is applied when the concrete-based panel is positioned in abutting relation with plate (16). Drilling screw (10) is then drilled through concrete-based panel (9) and connected to plate (16) to ensure that concrete-based panel (9) will not be separated from plate (16) due to the high hydrostatic pressure caused by the poured concrete, and therefore concrete-based panel (9) and PCP (30) will be assured of remaining mutually parallel.

It will be appreciated that leveling unit (80) may be employed in any embodiment described herein.

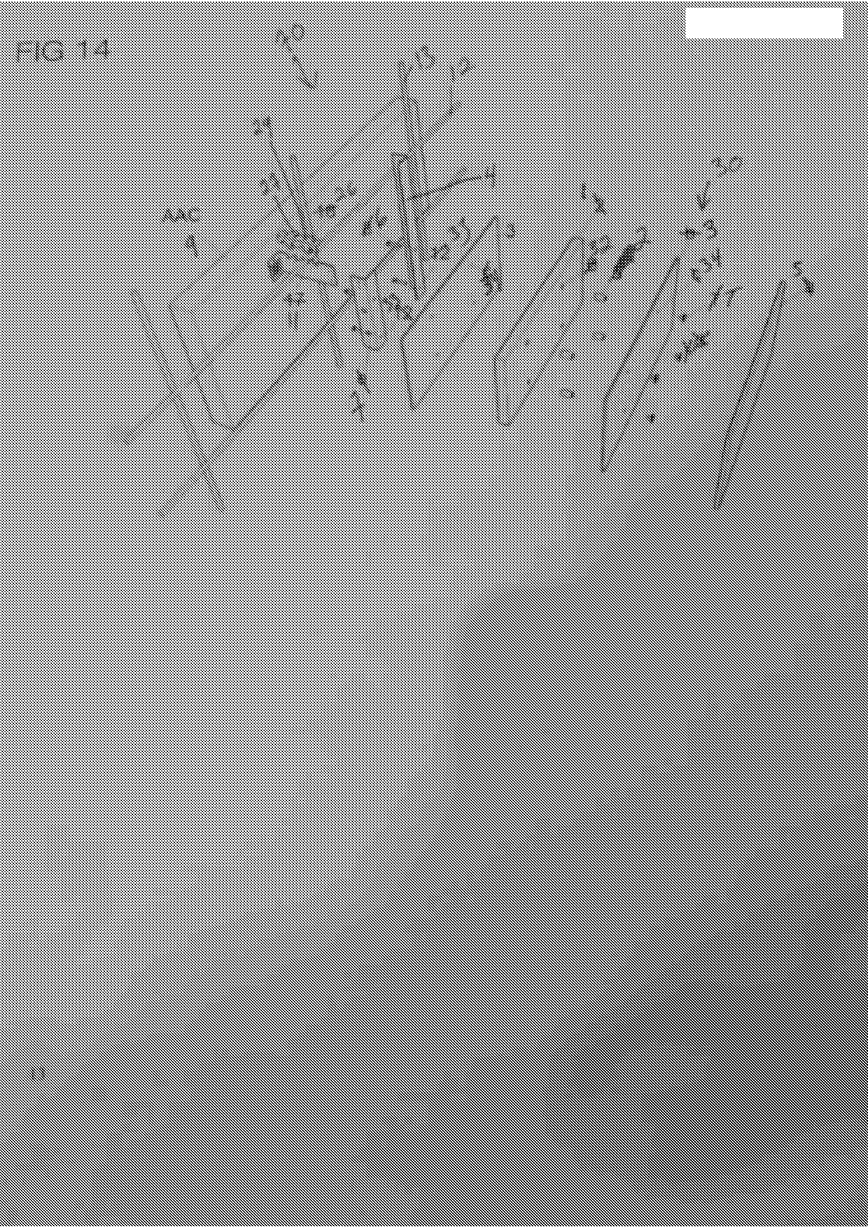

FIGS. 11 and 12 are two isometric views, respectively, of another lost form wall system (70) similar to wall system (50) of FIG. 6, but with the addition of a plurality of brackets (26), each adapted to support a vertical rebar element (13). Each bracket (26) is engaged with a bracket (11) adapted to support a horizontal rebar element (12).

FIG. 14 is an exploded view of wall system (70), showing PCP (30), including cladding plate (5), exterior and interior support boards (3) each formed with openings (34), insulating plate (1) formed with openings (32), socket element inserts (2) each insertable within an opening (32), and anchors (T) each insertable within an opening (34) of the exterior support board (3). Also shown are angled metal mount posts (4) and (7) each formed with openings (33), and bolts (6) each insertable within an opening (33), an opening (34), and an insert (2), and engageable with an anchor (T) to define a PCU.

Additionally shown are AAC panel (9) spaced from PCP (30), L-shaped bracket (11), horizontal rebar element (12) supportable by bracket (11), angled bracket (26), and vertical rebar element (13) supportable by bracket (26). The two sides of angled bracket (26), which are preferably perpendicularly spaced, are each configured with grooves (29) and openings (27).

While a first side of angled bracket (26) is in abutment with the long side of L-shaped bracket (11) and an opening (27) of bracket (26) is connected with a corresponding opening of bracket (11), such as by a screwed fastener, the second side of bracket (26) protrudes from the long side of bracket (11), as shown in FIG. 12. The interconnected openings are positioned at suitable locations that urge the grooves (29) at the first side of bracket (26) to be aligned with the grooves (23) of bracket (11) shown in FIG. 15A, so that a horizontal rebar element (12) will pass below the second side of bracket (26) and be received within one pair of the aligned grooves. The second side of bracket (26) sufficiently protrudes from the long side of bracket (11) to allow a vertical rebar element (13) to be received in, and secured by, a groove (23) of bracket (11).

FIG. 15B shows an alternative option of the option illustrated in FIG. 15A.

FIG. 16 illustrates a wall system (75) similar to wall system (70) of FIG. 12, but which is configured with a different type of vertical rebar supporting bracket (46). A perspective view of the interior of wall system (75) is shown to illustrate the structure of brackets (11) and (46).

The long side of L-shaped, horizontal rebar supporting bracket (11) is attached to long post (4), which is affixed to short post (7) by screws (15) to produce a RPM. The short side of bracket (11) is configured as a perforated, vertically oriented plate (16) that is parallel to, and adapted to be in abutment with, concrete-based panel (9). Perforated plate (16) is formed with a plurality of apertures (21), of at least three apertures or as many as tens of apertures, e.g. 40, to provide a matrix of apertures. Each aperture (21) is smaller sized than the diameter of drilling screw (10) drilled through concrete-based panel (9) and having a pointed end of a slightly smaller thickness than that of its cylindrical body. After the pointed end of a self-tapping or drilling screw (10) is received in one of the apertures (21), the aperture will be forced to expand after the bolt is penetrated deeper within concrete-based panel (9) and its cylindrical body spins through the interior of the aperture. By virtue of perforated plate (16), a construction worker does not have to carefully measure the location of drilling screw (10) since it will be assured of being able to penetrate one of the many apertures (21) provided with plate (16), to assist in fixating concrete-based panel (9) while being parallel to the PCPs (30). All perforated plates (16) of the wall system are coplanar in order to be abuttable with a concrete-based panel (9). The concrete-based panel (9) and perforated plate (16) shown in the foreground are associated with different tiers of wall system (75).

In this embodiment, angled vertical rebar supporting bracket (46) has a first side configured with two spaced tabs that are positioned in abutment with the long side of bracket (11) and a second rectangular side protruding from the long side of bracket (11). The first side of bracket (46) has two short and spaced teeth interposed between the tabs to engage a horizontal rebar element (12) introduced through an angled groove of bracket (11). The second side of bracket (46) is formed with a plurality of apertures (48) formed with radial projections to engage a vertical rebar element (13) received therein.

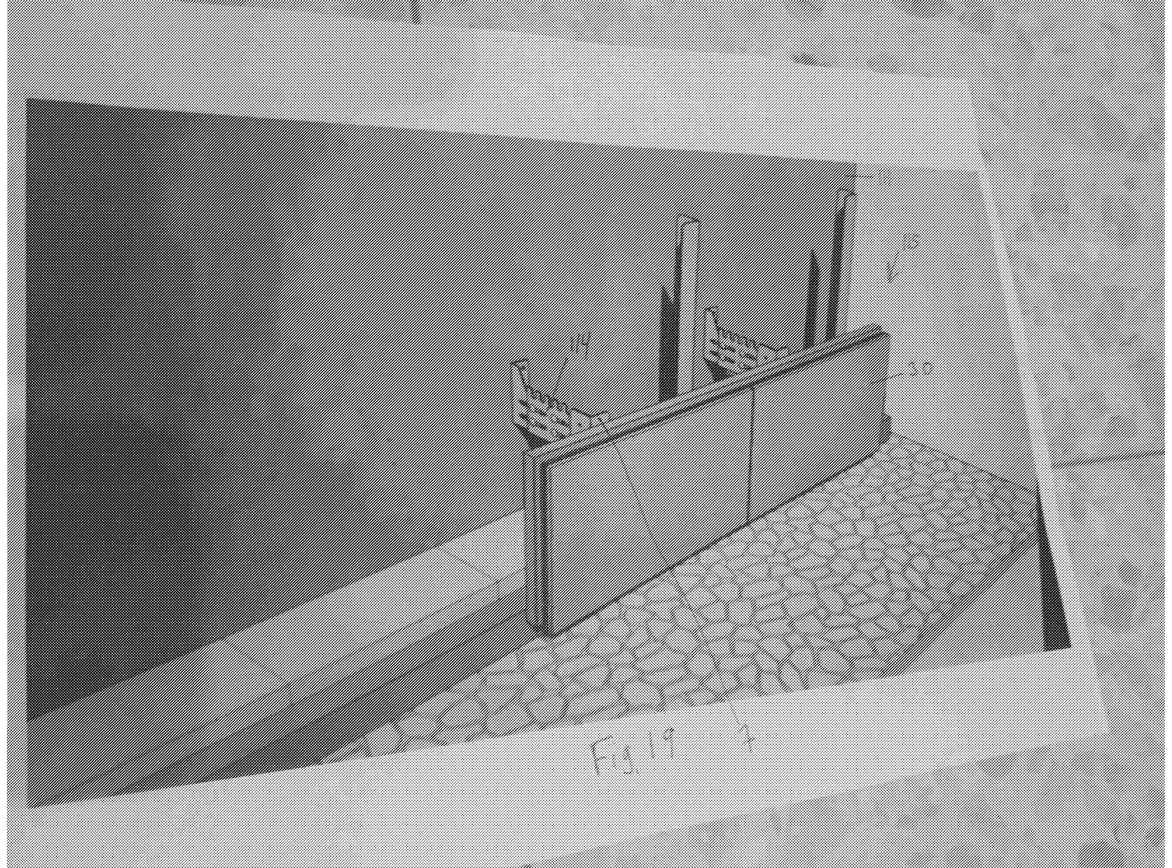

FIG. 18 illustrates wall system (75) after a PCP (30) to which handle bar unit (90) has been coupled is incorporated therewith.

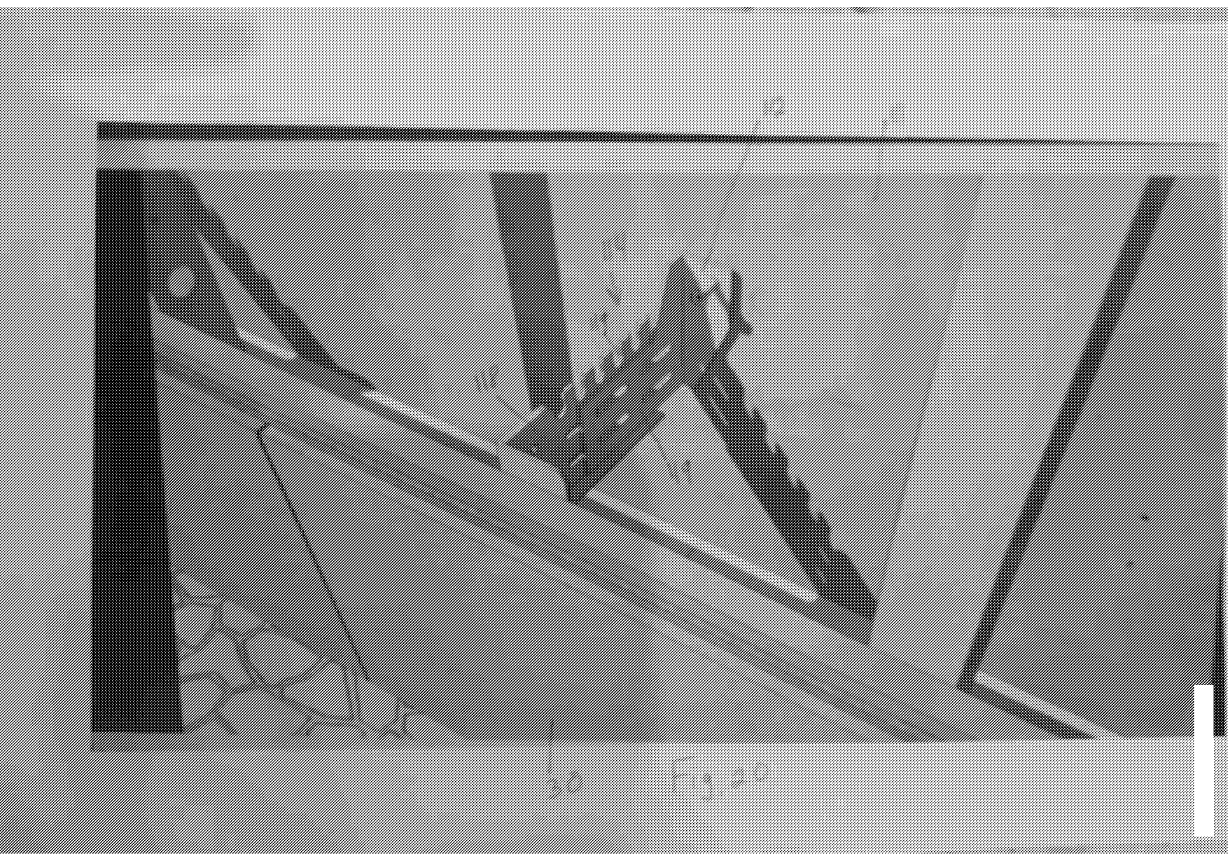

FIG. 19 illustrates a lost form wall system (115) for retrofitting a building with PCPs (30). A horizontal rebar supporting bracket (114) is connected to an existing wall (111) of a building to be retrofitted, which constitutes the interior lost form, and to an angled post (7) of each PCP (30).

As shown in FIG. 20, bracket (114) has a plurality of upper grooves (119) for supporting a horizontal rebar element, and can be interfaced with a vertical rebar supporting bracket if so desired. Bracket (114) may comprise two sections (118) and (119) that are slidable one with respect to the other in order to adjust the spacing between a PCP (30) and existing wall (111) and to define the desired thickness of the cast-in-place concrete wall, and also an abutment (112) substantially perpendicular to section (119) through which a fastener is connected to existing wall (111).

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A Gadded wall system for constructing cladded cast-in-place concrete walls that are each integrated with lost forms, comprising a self-supporting structure made of a plurality of prefabricated Gadded panels (PCPs) constituting an exterior lost form, at least one architectural element constituting an interior lost form, and a plurality of concrete integratable connecting units by which each of said PCPs is connected to said interior lost form.

2. The wall system according to claim 1, wherein each of the PCPs comprises a support board and a cladding plate that is factory adhered to said support board.

3. The wall system according to claim 2, wherein each of the PCPs comprises exterior and interior support boards, a socket element received in aligned openings formed in said exterior and interior support boards, and an insert anchor in contact with said exterior board and introduced in said socket element, wherein a fastener associated with one of the connecting units is introduced in said socket element and is engaged with said insert anchor to tighten the PCP, and the cladding plate is factory adhered to said exterior support board.

4. The wall system according to claim 3, wherein each of the PCPs further comprises an insulating plate interposed between the exterior and interior support boards and which is formed with an opening within which the socket element is received.

5. The wall system according to claim 4, wherein a first region of the insulating plate is configured with a tongue and a second region of the insulating plate is configured with a groove, to facilitate interlocking of adjacent PCPs by a tongue and groove arrangement.

6. The wall system according to claim 3, wherein each of the connecting units comprises an elongated metal mount in abutment with the interior support board and through an opening of which the fastener is introduced into the socket element, and a bracket connected to said metal mount which is connected to one of the architectural elements constituting an interior lost form.

7. The wall system according to claim 6, wherein first and second metal mounts are fixated together to produce a reinforced member that both presses on one PCP and vertically extends along two PCPs to ensure that said two PCPs will be vertically aligned.

8. The wall system according to claim 6, further comprising a handle bar unit that is detachably connectable to two of the metal mounts, to facilitate safe transfer of the PCP to a construction site.

9. The wall system according to claim 6, wherein the bracket is configured with one or more grooves to receive and support a horizontal rebar element.

10. The wall system according to claim 6, wherein one of the architectural elements constituting an interior lost form is a concrete-based panel.

11. The wall system according to claim 10, wherein the concrete-based panel is an autoclaved aerated concrete panel.

12. The wall system according to claim 10, wherein the bracket is configured with a perforated plate formed with a plurality of apertures and adapted to be in abutting relation with the concrete-based panel, through one of the apertures a drilling screw drilled through the concrete-based panel is able to be received in one of the apertures in order to fixate the interior and exterior lost forms together.

13. The wall system according to claim 12, wherein all perforated plates corresponding to each of the connecting units are coplanar.

14. The wall system according to claim 6, wherein the architectural element constituting an interior lost form is an existing wall of a building that will undergo a retrofitting operation.

15. The wall system according to claim 1, further comprising a leveling unit.
